(19) United States
(12) Patent Application Publication
(10) Pub. No.: US 2011/0235785 A1
(43) Pub. Date: Sep. 29, 2011

(54) AUXILIARY GRID ELECTRODE FOR X-RAY TUBES

(75) Inventor: Rolf Karl Otto Behling, Norderstedt (DE)

(73) Assignee: KONINKLIJKE PHILIPS ELECTRONICS N.V., EINDHOVEN (NL)

(21) Appl. No.: 13/131,086

(22) PCT Filed: Nov. 23, 2009
(86) PCT No.: PCT/IB2009/055282

§ 371 Date: May 25, 2011

(30) Foreign Application Priority Data
Nov. 26, 2008 (EP) 08169944.9

(51) Int. Cl. H01J 35/14

(52) U.S. Cl. 378/138

(57) ABSTRACT

The present invention refers to an X-ray tube of the rotary-anode type which comprises at least one temporarily negatively biased auxiliary grid electrode (119) with an aperture through which an electron beam (115) emitted by a tube cathode's thermoionic electron emitter (111) can pass. As an alternative thereto, the auxiliary grid electrode (119) may also be positively biased so as to enhance electron emission from a thermoionic electron emitter (111). The auxiliary grid electrode may thereby be connected to a supply voltage U_{AUX} of a controllable voltage supply unit by means of a feedthrough cable (120) serving as a feeding line for providing the main control grid (112) with a grid supply voltage U_{G}.

### FIELD OF THE INVENTION

The present invention refers to the field of high-power X-ray sources, in particular to X-ray tubes of the rotary-anode type which can advantageously be applied in the field of material inspection or in the scope of medical X-ray imaging applications. According to the invention, an X-ray tube of the kind mentioned above is disclosed which comprises an at least one temporarily negatively biased auxiliary grid electrode with an aperture through which an electron beam emitted by a tube cathode's thermoionic electron emitter can pass. As an alternative thereto, the auxiliary grid electrode may also be positively biased so as to enhance electron emission from the emitter. The auxiliary grid electrode may thereby be connected to a supply voltage of a controllable voltage supply unit by means of a feedthrough cable serving as a feeding line for providing the main control grid with a grid supply voltage.

### BACKGROUND OF THE INVENTION

The electron emission originating from the surface of a thermoionic electron emitter strongly depends on the “pulling” electric field which is usually generated by the X-ray tube's anode. For enabling fast on/off switching, it is known from the relevant prior art that X-ray tubes of the rotary-anode type may be equipped with a grid electrode placed in the vicinity placed in front of the tube cathode's electron emitter. In ancient radio tubes, said grid electrode was realized as a grid of wires. Therefore, this electrode is still called “grid” despite it looks rather aperture-like in modern X-ray tubes and is a part of the electrostatic focusing of the cathode cup. To shut off the electron beam completely, a so-called cut-off voltage U_{co} is applied to the grid electrode which generates a repelling field and is usually given by the absolute value of the potential difference between the electron emitter and the grid electrode. The resulting electric field at the emitter surface is the sum of the grid and the anode generated field. If the total field is repelling on all locations on the electron emitter, electron emission is completely cut off.

### SUMMARY OF THE INVENTION

When being equipped with a grid electrode as mentioned above, conventional X-ray tubes are typically faced with a couple of severe problems, which can be summarized as follows:

A first problem consists in the fact that the cut-off voltage at the main control grid of a grid switch cathode needs to be proportional to the tube voltage (the latter being defined as the anode-to-cathode potential difference), which can in some cases, where the tube voltage is comparatively high, not securely be handled with present X-ray tubes and present insulation technology for operating these X-ray tubes. New grid designs are characterized by a large through grip and a large pulling field on the emitter surface for high electron emission. In these cases, a high grid cut-off voltage is needed. Given the high temperatures in the cathode, insulation technology is a very difficult issue. To ensure reliable operation, the grid cut-off voltage needs to be limited. At present, there is a gap between voltage requirements and the available insulation technology.

Under given limitations of designs which take the range of available grid cut-off voltages into account by reduction of the through grip, a second problem is poor electron emission at low tube voltages, such as e.g. needed for vascular imaging applications. On the other hand, high emitter temperatures, applied for compensation, cut down the life time of the thermoionic electron emitter.

Furthermore, severe damages of the X-ray tube caused by vacuum arc discharges originating from the negatively charged cathode surface or from the thermoionic electron emitter may occur. Many vacuum discharges start from the cathode head. If they end at ground potential (which exists on the surface of the tube envelope, herein also referred to as “tube frame”), the high-voltage tube circuit, at least the high-voltage feedthrough cables, is/are being rapidly discharged such that severe damage to the X-ray tube or insulation between the cable lines may occur and trigger even more discharges. If not limited properly, arc discharges may raise the X-ray tube current to several kilo amperes with extremely large energy density at the foot point of the discharge path, which may destroy the electron emitter and/or release particles. Aside therefrom, this may further jeopardize the high voltage stability of the X-ray tube. Furthermore, reflections on the cable may create electromagnetic compatibility (EMC) issues.

In view thereof, it is an object of the present invention to provide an X-ray tube equipped with a grid electrode which overcomes all the problems mentioned above by providing limited grid cut-off voltages and allowing emission enhancement and arc discharge current limitation.

This object is solved by an X-ray tube according to anyone of the accompanying claims. Advantageous aspects of the invention will become evident from the subordinate claims.

As claimed herein, a first aspect of the present invention refers to a high-power X-ray tube of the rotary-anode type, said X-ray tube comprising a rotating anode, a cathode equipped with a thermoionic electron emitter and an at least temporarily negatively biased main control grid arranged in a vacuum envelope (also referred to as “tube frame” or “tube envelope”) between the thermoionic electron emitter and the rotating anode, wherein said X-ray tube further comprises a biased aperture auxiliary grid electrode through which an electron beam emitted by the thermoionic electron emitter of the X-ray tube's cathode passes after passing the main control grid and before impinging on a focal spot in a target area of the tube anode's X-ray emitting surface.

A further aspect of the present invention relates to a method for operating a high-power X-ray tube as described above, wherein the electron beam is switched on by supplying the aperture auxiliary grid electrode with an electrode potential which is either close to the voltage potential of the electric field at the space point of its location within the X-ray tube or lies at a more positive voltage potential U_{Aux} so as to enhance cathode emission. For switching this electron beam off, the aperture auxiliary grid electrode is supplied with a negative voltage potential U_{Aux}.

The timing of switching the aperture auxiliary grid electrode off by supplying it with a negative voltage potential U_{Aux} such as described above may be synchronized with an application of a negative grid cut-off voltage U_{co} to the X-ray tube's main control grid, said grid cut-off voltage being given by the potential difference between the tube cathode's thermoionic electron emitter and the main control grid. On the other hand, the process of switching the aperture auxiliary grid electrode on by supplying it with a positive voltage potential U_{Aux} may be synchronized with said grid cut-off voltage U_{co} being switched off.

Furthermore, the present invention is directed to an X-ray examination system which comprises an X-ray tube as described above, and finally a software program configured for performing the above-described method when running on a control unit of such an X-ray examination system is proposed.

### BRIEF DESCRIPTION OF THE DRAWINGS

Advantageous features, aspects, and advantages of the invention will become evident from the following description, the appended claims and the accompanying drawings. Thereby,

FIG. 1 shows a cut-open 3D view of Philips' SRC 120 0508 X-ray tube as known from the prior art as an X-ray tube of the rotary-anode type,

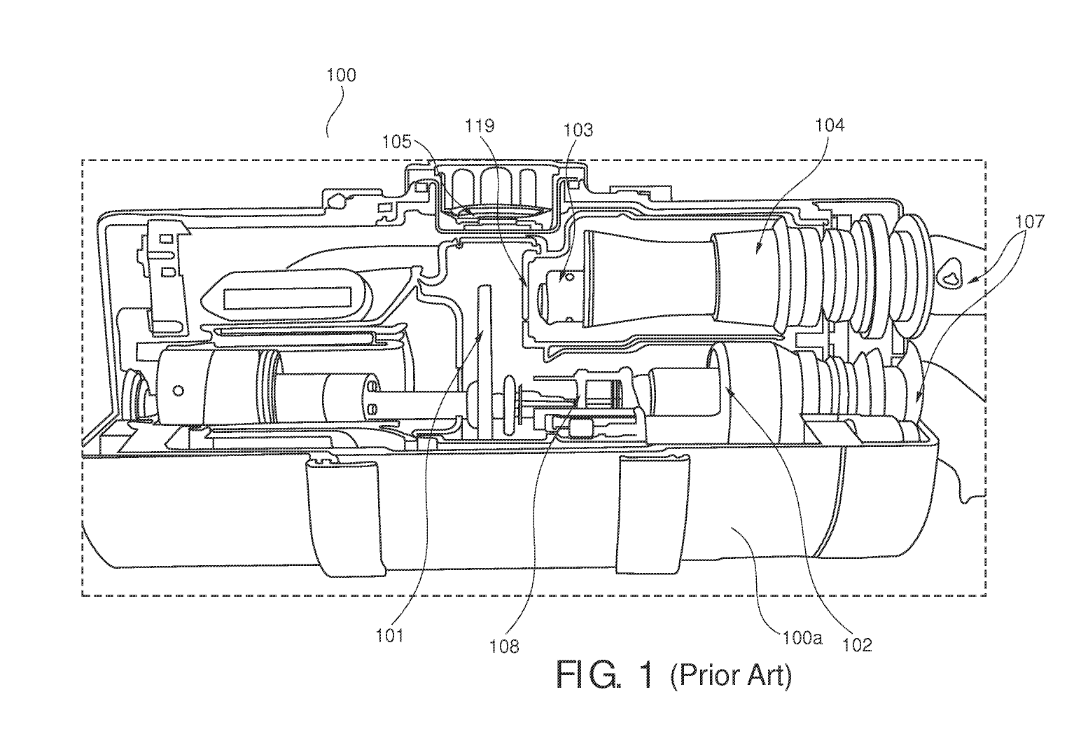

FIG. 2 shows a cross-sectional schematic view of an X-ray tube of the rotaryanode type according to the present invention, which comprises an auxiliary electrode (grid electrode or control grid) realized as a circular plate with an aperture for passing an electron beam emitted by a thermoionic electron emitter placed in front of the tube cathode,

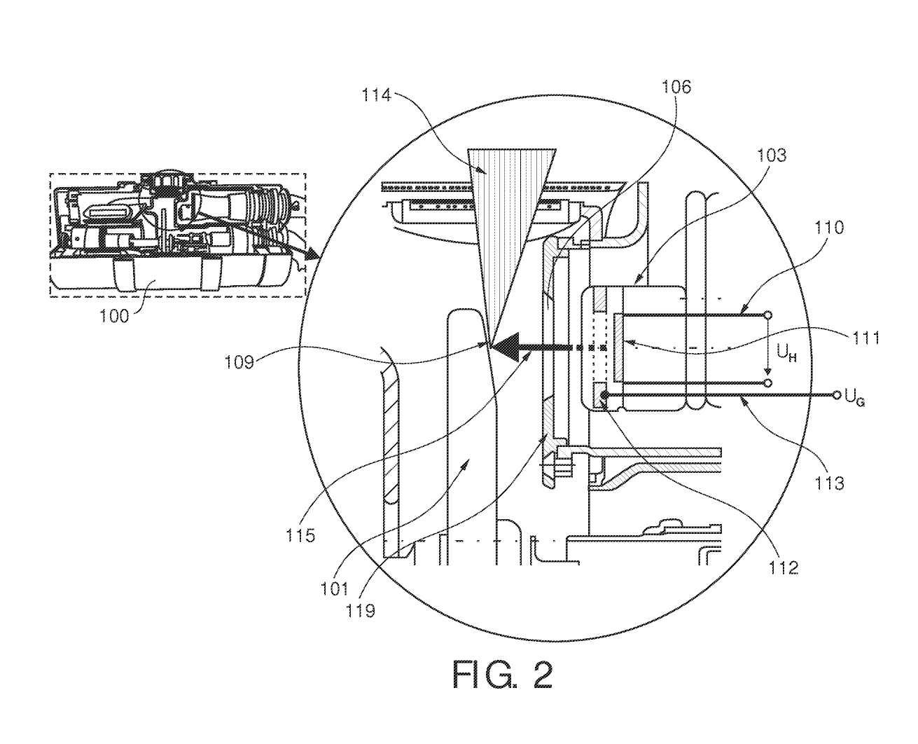

FIG. 3 shows a more detailed cross-sectional view of the embodiment depicted in FIG. 2, and

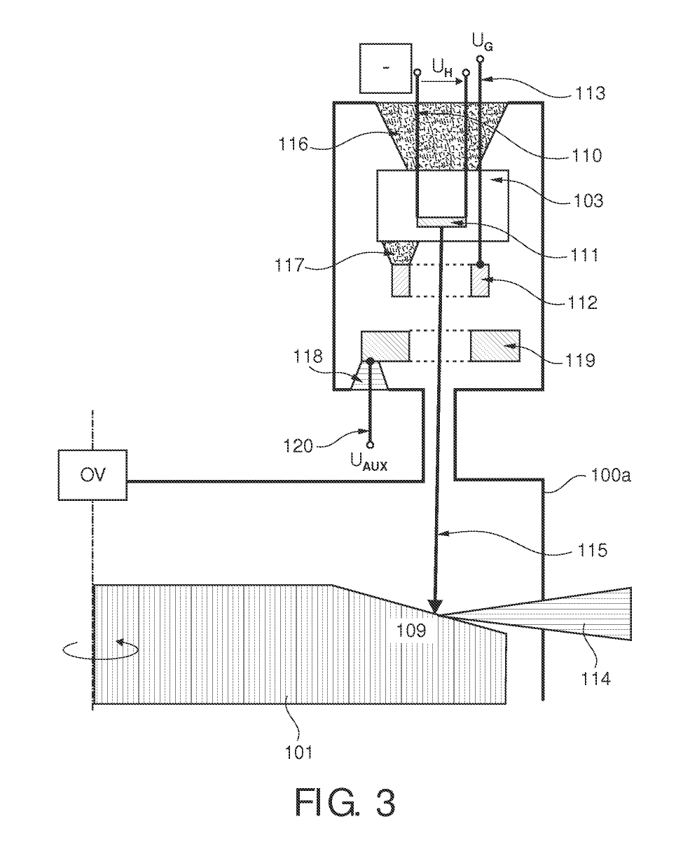

FIG. 4 shows an cross-sectional schematic view of the proposed X-ray tube according to a first exemplary embodiment of the present invention where said auxiliary electrode is connected to a controllable voltage supply, which allows for a secure grid switching and an enhanced electron emission at low tube voltages.

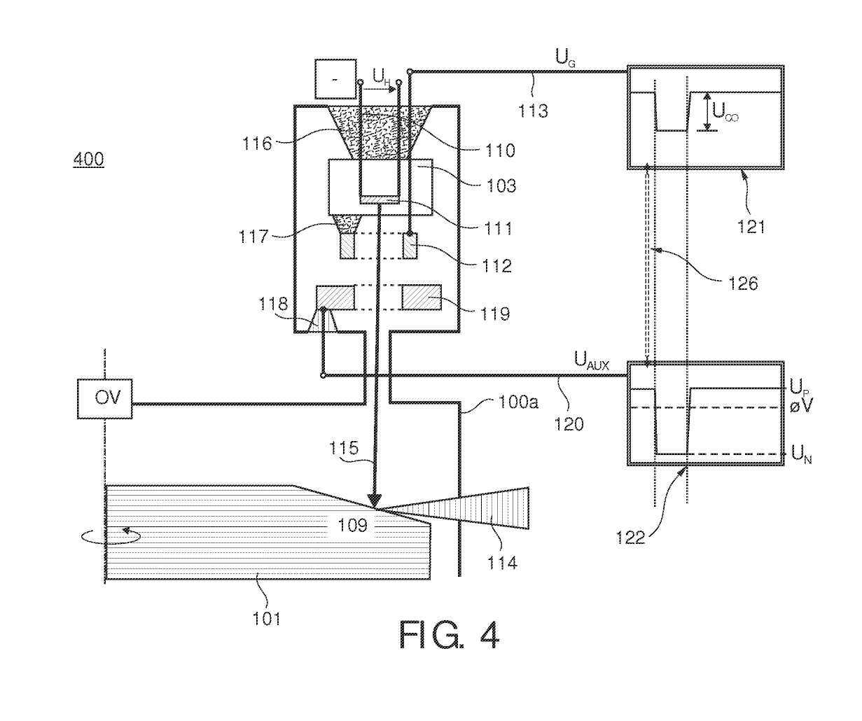

### DETAILED DESCRIPTION OF THE PRESENT INVENTION

In the following, different embodiments of the present invention will be explained in detail with respect to special refinements and referring to the accompanying drawings.

A first exemplary embodiment of the present invention, which provides for an enhanced grid switching, refers to an X-ray tube of the rotary-anode type, referred to by reference number 100. According to the invention, said tube is equipped with an auxiliary grid electrode 119, placed between the X-ray tube's rotating anode 101 and cathode 103, wherein said auxiliary grid electrode is characterized by an aperture 106 through which an electron beam 115 originating from a thermoionic electron emitter 111 (which may e.g. be realized as a tungsten wire) passes after passing the X-ray tube's main control grid 112 and before impinging on a focal spot 109 in a target area of the tube anode's X-ray emitting surface. In new single-ended tube designs, there is hardly any current of backscattered electrons (scattered from the anode) in the cathode area. The auxiliary grid electrode 119 therefore operates substantially power-less and may be connected to a controllable auxiliary electrode voltage supply 122. For switching electron beam 115 on, electrode potential U_{Aux} of the auxiliary grid electrode 119 may either be set close to the voltage potential of the electric field at the space point of its location (in case such an electrode potential should not already exist) or to a more positive voltage potential so as to enhance cathode emission (particularly at low tube voltages where high emission may be an issue). For switching this electron beam off, auxiliary grid electrode 119 may be supplied with a negative voltage, which may be synchronized with the application of grid cut-off voltage U_{co} to the X-ray tube's main control grid 112, which is placed in front of the thermoionic electron emitter 111 (as seen from the anode).

This implies the advantage that cut-off voltage U_{co} is reduced to values which can be handled with existing insulation technique. Furthermore, high tube emission currents are possible at low tube voltage, which allows for good image quality, and finally a further benefit consists in the fact that auxiliary grid electrode 119 reduces arcing from the cathode 103.

A second exemplary embodiment of the present invention refers to an X-ray examination system (such as e.g. implemented in an X-ray, CT or 3DRA device) which comprises an X-ray tube of the rotary-anode type as described above with reference to said first exemplary embodiment.

### Applications of the Present Invention

As already mentioned above, the invention can advantageously be applied in the field of material inspection or in the scope of medical X-ray imaging applications with high-standard and high-security requirements as concerns grid switching, electron emission and discharge current limitation.

While the present invention has been illustrated and described in detail in the drawings and in the foregoing description, such illustration and description are to be considered illustrative or exemplary and not restrictive, which means that the invention is not limited to the disclosed embodiments. Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. Furthermore, any reference signs contained in the claims should not be construed as limiting the scope of the invention.

TABLE OF USED REFERENCE NUMBERS AND THEIR MEANINGS:

| | |
|---|---|
| 100 | Rotary-anode type X-ray tube |
| 100a | Tube frame (vacuum envelope) |
| 101 | Rotating anode (anode voltage potential: e.g. U_{A} = +75 kV) |
| 102 | Anode insulator |
| 103 | Cathode (cathode voltage potential: e.g. U_{C} = −75 kV) |
| 104 | Cathode insulator |
| 105 | X-ray port |
| 106 | Electron aperture of auxiliary grid electrode 119 |
| 107 | High-voltage cables (i.e., heating current feed 110 and grid voltage feed 113) |
| 108 | Ball bearing system |
| 109 | Focal spot |
| 110 | Heating current feedthrough line |
| 111 | Thermoionic electron emitter (e.g. tungsten wire) |
| 112 | Main control grid, at least temporarily negatively biased (U_{G} < 0) |
| 113 | Grid voltage feedthrough line |
| 114 | X-rays |
| 115 | Electron beam |
| 116 | High-voltage insulator |
| 117 | Grid insulator |
| 118 | Insulator |
| 119 | Single-aperture auxiliary grid electrode (e.g. realized as a large circular plate with a hole) |
| | which may e.g. be negatively biased (U_{Aux} < 0) |
| 120 | Auxiliary voltage potential feedthrough |
| 121 | Grid voltage supply |
| 122 | Auxiliary electrode voltage supply |
| 126 | Synchronization |
| 400 | Embodiment “Grid switching and emission enhancement” |
| U_{A} | Anode voltage potential (positive) |
| U_{co} | Grid cut-off voltage (U_{co} = \|U_{H} − U_{G}\| with U_{H} = U_{C}) |
| U_{Aux} | Voltage potential of the auxiliary grid electrode 119 (negative), for example |
| | U_{Aux} = 0 kV (electron beam on, high electric field strength): large emission at low U_{C}, |
| | U_{Aux} ≈ −15 kV: regular operation at elevated U_{C}, |
| | U_{Aux} = −30 kV: electron beam cut off, pulse operation |
| U_{C} | Cathode voltage potential (negative), for example |
| | U_{C} = −60 kV: enhanced emission and emitter life, |
| | U_{C} = −90 kV: enhanced emission and emitter life, |
| | U_{C} = −125 kV (= minimum value): cut-off problem solved |
| U_{G} | Voltage potential of main control grid 112: |
| | e.g. U_{G} = −6 kV (reduced from −12 kV) |
| U_{H} | Heating voltage of thermoionic electron emitter 111 (identical with cathode voltage |
| | potential U_{C}) |
| U_{N} | Negative minimum value of auxiliary voltage potential U_{Aux}, helps to cut off the tube |
| | current |
| U_{P} | Positive maximum value of auxiliary voltage potential U_{Aux}, used for achieving an |
| | enhanced cathode emission |

1. A high-power X-ray tube of the rotary-anode type (100), comprising a rotating anode (101), a cathode (103) equipped with a thermoionic electron emitter (111) and an at least temporarily negatively biased main control grid (112) arranged in a vacuum envelope (100a) between the thermoionic electron emitter and the rotating anode, said X-ray tube further comprising a biased aperture auxiliary grid electrode (119) through which an electron beam (115) emitted by the thermoionic electron emitter (111) of the X-ray tube's cathode (103) passes after passing the main control grid (112) and before impinging on a focal spot (109) in a target area of the tube anode's X-ray emitting surface.

2. A method for operating a high-power X-ray tube according to claim 1, wherein the electron beam (115) is switched on by supplying the aperture auxiliary grid electrode (119) with an electrode potential which is either close to the voltage potential of the electric field at the space point of its location within the X-ray tube (100) or lies at a more positive voltage potential (U_{Aux}) so as to enhance cathode emission.

3. The method according to claim 2,
wherein the electron beam (115) is switched off by supplying the aperture auxiliary grid electrode (119) with a negative voltage potential (U_{Aux}).

4. The method according to claim 3,
wherein the process of switching the aperture auxiliary grid electrode (119) off by supplying it with a negative voltage potential (U_{Aux}) such as proposed in claim 5 is synchronized with an application of a negative grid cut-off voltage (U_{co}) to the X-ray tube's main control grid (112), said grid cut-off voltage being given by the potential difference between the tube cathode's thermoionic electron emitter (111) and the main control grid (112).

5. The method according to claim 4, wherein the process of switching the aperture auxiliary grid electrode (119) on by supplying it with a positive voltage potential (U_{Aux}) such as proposed in claim 4 is synchronized with said grid cut-off voltage (U_{co}) being switched off.

6. An X-ray examination system comprising an X-ray tube (100) according to claim 1.

7. A software program configured for performing a method according to claim 2 when running on a control unit of an X-ray examination system.
